(19) United States
(12) Patent Application Publication
(10) Pub. No.: US 2022/0079711 A1
(43) Pub. Date: Mar. 17, 2022

(54) DENTAL TREATMENT TOOL GUIDING DEVICE

(71) Applicants: TOEI ELECTRIC CO., LTD., Tokyo (JP); THE YOSHIDA DENTAL MFG. CO., LTD., Tokyo (JP)

(72) Inventors: Masahiro OTSUKA, Tokyo (JP); Michizo YAMANAKA, Tokyo (JP)

(21) Appl. No.: 17/424,678

(22) PCT Filed: Jan. 15, 2020
(86) PCT No.: PCT/JP2020/001106

§ 371 Date: Jul. 21, 2021

(30) Foreign Application Priority Data
Jan. 25, 2019 (JP) 2019-011360

(51) Int. Cl. A61C 5/42

(52) U.S. Cl. CPC A61C 5/42

(57) ABSTRACT

A dental treatment tool guiding device (1) is a device for guiding a dental treatment tool (3) to a treatment target position (g) of a tooth (a) to be treated. The dental treatment tool guiding device (1) is provided with a guiding tool (2) that has an inlet port (2a), a hollow portion (2b), and an outlet port (2c) for inserting the dental treatment tool (3) therethrough, and that guides the dental treatment tool (3). The outlet port (2c) is open in a direction different from the introducing direction of the dental treatment tool (3). The hollow portion (2b) extends in a direction from the inlet port (2a) to the tip of the guiding tool (2), and has a tip side curved in the direction of the outlet port (2c).

### TECHNICAL FIELD

The present invention relates to a dental treatment tool guiding device used for guiding a dental treatment tool such as a dental cutting tool, a radiation nozzle of a dental laser treatment device, an ultrasonic scaler chip, a root canal camera, a water pipe, and an air pipe to an opening direction of a lateral branch extending from inside of a root canal to a periodontal ligament space.

### BACKGROUND ART

A lateral branch detection device disclosed in Patent Literature 1 has heretofore been known as a device configured to detect a position of a lateral branch extending from a root canal to a periodontal ligament space, and to detect an opening direction of the lateral branch. The lateral branch detection device disclosed in Patent Literature 1 is a device that displays presence or absence of a lateral branch on a display unit by using a transitional waveform of display data that changes along with insertion of a measurement electrode into a root canal.

### CITATION LIST

### Patent Literature

Patent Literature 1: Japanese Patent Publication No. 6035390

### SUMMARY OF INVENTION

### Technical Problem

However, even when the position of the lateral branch is identified by the lateral branch detection device of Patent Literature 1, a tip end part of a reamer or a file for a root canal treatment has to be slightly bent and an opening portion of a lateral branch opening has to be searched by using tactile sense of a hand while delicately moving the bent portion from side to side or up and down in order to treat the lateral branch.

Accordingly, in the case of treating the lateral branch with the dental treatment tool such as the reamer and the file, an operator needs to be skillful to perform the treatment while inserting the dental treatment tool in hand into the lateral branch by using the tactile sense.

In the meantime, in a conventional case of removing tartar that adheres to a tooth in a periodontal pocket, an operator needs to be skillful to perform the treatment while inserting a dental treatment tool such as a curette in hand into the periodontal pocket by using the tactile sense.

Given the circumstances, it is an object of the present invention to provide a dental treatment tool guiding device which is capable of easily guiding a dental treatment tool to a position to be treated.

### Solution to Problem

To attain the object, a dental treatment tool guiding device according to the present invention provides a dental treatment tool guiding device configured to guide a dental treatment tool to a position to be treated of a tooth to be treated, which includes: a guiding tool provided with an inlet port, a hollow portion, and an outlet port for insertion of the dental treatment tool, and configured to guide the dental treatment tool. Here, the outlet port is open in a direction different from a direction of introduction of the dental treatment tool, and the hollow portion extends from the inlet port to a direction of a tip end of the guiding tool and a tip end part side of the hollow portion is curved in a direction to the outlet port.

### Advantageous Effects of Invention

According to the present invention, it is possible to provide a dental treatment tool guiding device which is capable of easily guiding a dental treatment tool to a position to be treated.

### BRIEF DESCRIPTION OF DRAWINGS

FIG. 1 is a schematic enlarged perspective view showing an example of a dental treatment tool guiding device according to an embodiment of the present invention.

FIG. 2 is a schematic enlarged vertical cross-sectional view showing the example of the dental treatment tool guiding device.

FIG. 3 is a schematic enlarged front view showing the example of the dental treatment tool guiding device.

FIG. 4 is a schematic enlarged front view showing a first modified example of the dental treatment tool guiding device according to the embodiment of the present invention.

FIG. 5 is a schematic enlarged exploded perspective view showing the first modified example of the dental treatment tool guiding device according to the embodiment of the present invention.

FIG. 6 is an enlarged schematic vertical cross-sectional view of a substantial part showing a second modified example of the dental treatment tool guiding device according to the embodiment of the present invention.

FIG. 7 is an enlarged schematic vertical cross-sectional view of a substantial part showing a modified example of the second modified example of the dental treatment tool guiding device according to the embodiment of the present invention.

FIG. 8 is an enlarged schematic vertical cross-sectional view of a substantial part showing a third modified example of the dental treatment tool guiding device according to the embodiment of the present invention.

FIG. 9 is an enlarged schematic perspective view of a substantial part showing the third modified example of the dental treatment tool guiding device according to the embodiment of the present invention.

FIG. 10 is an enlarged schematic vertical cross-sectional view of a substantial part showing a fourth modified example of the dental treatment tool guiding device according to the embodiment of the present invention.

### DESCRIPTION OF EMBODIMENTS

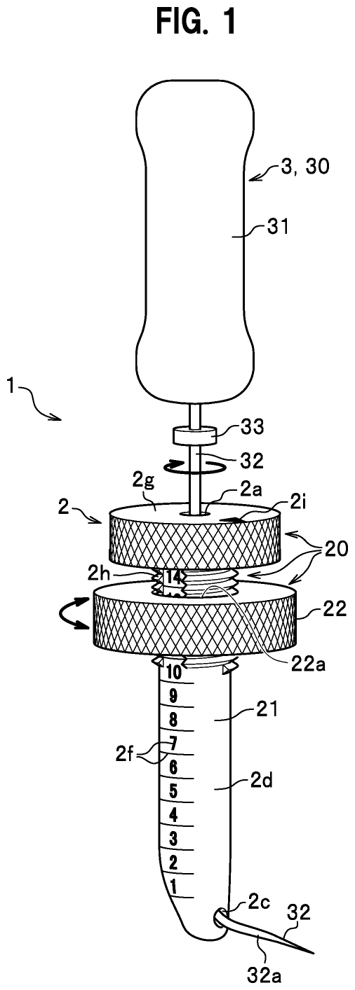

First, a dental treatment tool guiding device 1 according to an embodiment of the present invention will be described with reference to FIGS. 1 to 3.

Note that this embodiment will be described on the assumption that a support portion 31 side of a dental treatment tool 3 is an upper direction of the dental treatment tool guiding device 1 shown in FIG. 1 while a tip end side of a guiding tool 2 is a lower direction thereof.

### <<Dental Treatment Tool Guiding Device>>

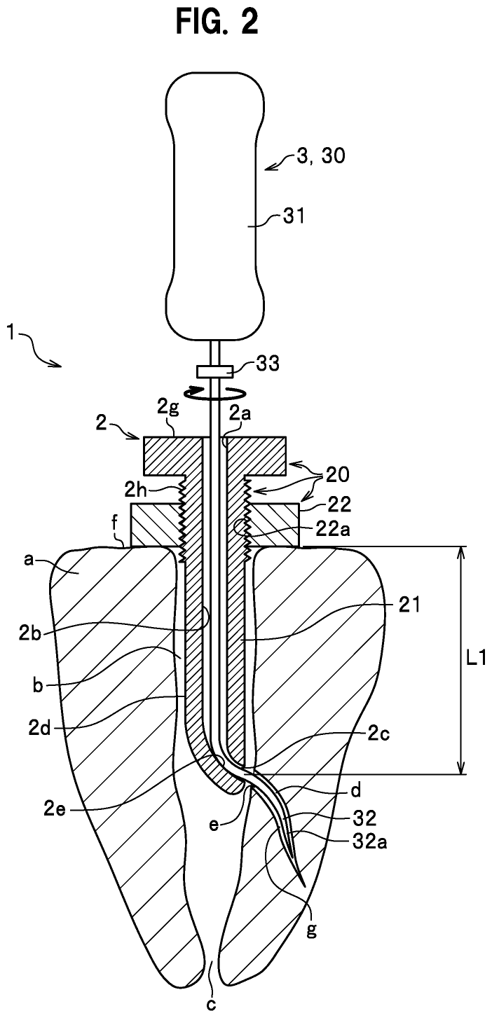

As shown in FIG. 2, the dental treatment tool guiding device 1 is a tool guiding device for guiding a dental treatment tool 3 such as a dental cutting tool to a position g to be treated of a tooth a to be treated. Before using the dental treatment tool guiding device 1, an opening direction and a position (a depth L1) of a lateral branch d that extends from a root canal b to a periodontal ligament space (the tooth a to be treated) are detected and confirmed by using a lateral branch opening direction detection device (not illustrated) or the like, and then the dental treatment tool guiding device 1 is used. The dental treatment tool guiding device 1 includes a guiding tool 2, which is provided with an inlet port 2a, a hollow portion 2b, and an outlet port 2c for inserting the dental treatment tool 3, and configured to guide the dental treatment tool 3 to the position g to be treated.

Before explaining the guiding tool 2, a description will be given of the dental treatment tool 3 for treating the lateral branch d, the lateral branch opening direction detection device for detecting the opening direction and the position (an angle) of the lateral branch d, a root canal meter, and a root canal camera.

### <Dental Treatment Tool>

As shown in FIG. 2, the dental treatment tool 3 used with the dental treatment tool guiding device 1 only needs to be designed to treat the tooth a to be treated and the tool is not limited to a particular type. The dental treatment tool 3 is a tool or a device used for a dental treatment, examples of which include a reamer, a file, a Gates drill, a cleanser, a square broach, a scaler, a radiation nozzle (a radiation fiber) of a dental laser treatment device, a scaler chip for an ultrasonic root canal treatment instrument, a root canal camera for monitoring the lateral branch d, a water pipe, an air supply pipe, a medical solution supply pipe, a spray pipe, an exhaust pipe, a drain pipe, and the like.

The dental treatment tool 3 is used for performing a treatment to irrigate, dry, and sterilize the lateral branch d after enlargement, a treatment to dissolve and clean a smear layer generated on a root canal wall i as a consequence of enlarging and forming the lateral branch d, a drying treatment using a sodium hypochlorite (NaClO) solution as a medical solution or by using Er-YAG laser, observation of the lateral branch d, and so forth by using any of the aforementioned tools and devices, for example.

As described above, the dental treatment tool 3 serves as a treatment unit for enlarging, irrigating, drying, or sterilizing the lateral branch d formed at the root canal b of the tooth a to be treated, or as an observation unit for observing the inside of the lateral branch d.

In the following, an example of the dental treatment tool 3 will be described while citing a case of using a dental cutting tool 30 formed from a reamer or a file as an example.

Here, the reamer and the file are dental tools used when performing a treatment to file a tooth substance such as the root canal b infected with bacteria. There are reamers and files that are hand-operated and there are also reamers and files that are mechanically operated by using dental engines. Meanwhile, the reamers and files in various sizes which are made of various metal materials. A reamer is a tool provided with a blade for cutting while being rotated. A file is a tool provided with a blade for filing in a scraping manner.

As shown in FIG. 2, the dental treatment tool 3 (the dental cutting tool 30) includes a support portion 31, a needle portion 32 having a base end part fixed to the support portion 31 and being provided with a blade part 32a, and a stopper 33 provided at a position close to the base end part of the needle portion 32.

The support portion 31 is a position to be gripped by a hand of an operator or to be fixed to a jig or a holder. The support portion 31 is formed into a substantially columnar shape, for example.

The needle portion 32 is a needle-shaped insertion part to be inserted from the inside of the root canal b into the lateral branch d. The blade part 32a for cutting the lateral branch d is formed at a position close to a tip end part side of the needle portion 32. The blade part 32a is a cutting part for cutting the lateral branch d and the like.

The stopper 33 is a deterrent portion for limiting a depth of insertion of a tip end of the needle portion 32 into the lateral branch d by coming into contact with an upper end surface of a knob 2g of the guiding tool 2. The stopper 33 is formed from a disc-shaped member fixed to an appropriate position at an upper part of the needle portion 32, for example.

### <Lateral Branch Opening Direction Detection Device>

The not-illustrated lateral branch opening direction detection device is a commercially available device such as the one disclosed in Patent Literature 1. The lateral branch opening direction detection device includes: a root canal meter having a lateral branch detection function and provided with a power supply, a control unit, a display unit, and the like; a lateral branch position detection unit connected to the root canal meter and provided with a lateral branch direction detection electrode; and a meter connection unit. The lateral branch opening direction detection device can automatically detect a position in a root canal axial diameter direction of the lateral branch d that extends from the root canal b to the periodontal ligament cavity from a position of an opening at the time of detection of a minimum value of a current value flowing to a lateral branch detection opening of the lateral branch direction detection electrode.

### <Root Canal Meter>

The not-illustrated root canal meter is a commercially available device such as the one disclosed in Patent Literature 1. The root canal meter is a device having the lateral branch detection function to perform measurement of a root canal length, detection of presence or absence of the lateral branch d, and display of a position of presence of the lateral branch d, which are carried out prior to a root canal treatment when treating the root canal b of the tooth a to be treated. The root canal meter includes a power supply, a signal switch unit, a matching unit, an amplification unit, a transformation unit, a data processing unit, a first storage unit, a second storage unit, a display unit, a control unit, and a meter connection unit provided with an earth electrode and a lead line. The root canal meter also functions as a notification unit that notifies of a position of the lateral branch detection opening. The root canal meter is configured to detect a position of a tip end of the lateral branch direction detection electrode inserted into the root canal b of the tooth a to be treated and to display the detected position on the display unit. Moreover, the root canal meter is configured to perform notification by using an icon of the notification unit when the opening of the lateral branch direction detection electrode comes close to the lateral branch d.

### <Root Canal Camera>

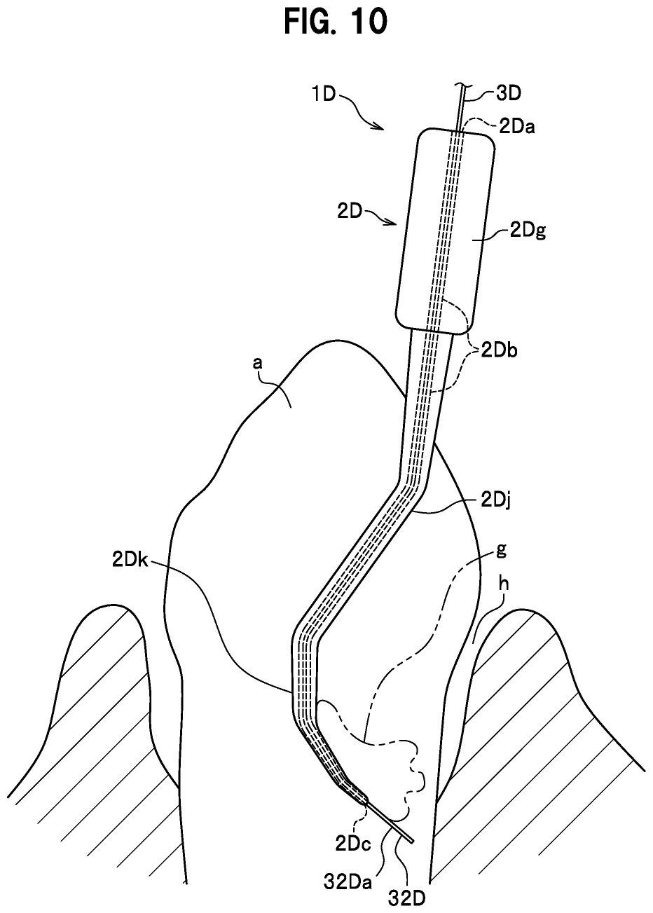

The not-illustrated root canal camera is a commercially available small diameter endoscope for inserting an endoscope insertion unit into the root canal b of the tooth or into a periodontal pocket h (see FIG. 10) thereof and shooting the inside of the root canal b or the inside of the periodontal pocket h (see Japanese Patent Application Publication No. 2004-65623, for example).

### <Guiding Tool>

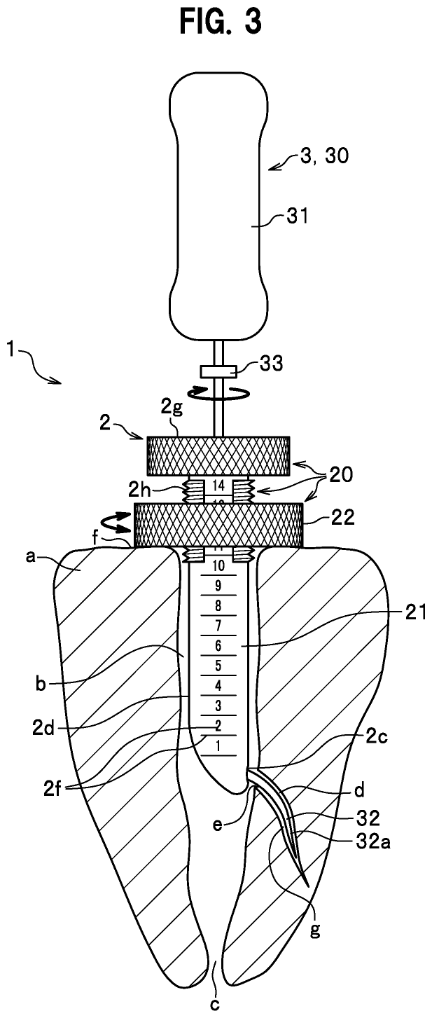

As shown in FIGS. 2 and 3, the guiding tool 2 is a guide for guiding a tip end region of the needle portion 32 of the dental treatment tool 3 to a lateral branch opening e. The guiding tool 2 includes a guide member 21 that guides the needle portion 32 of the dental treatment tool 3, an adjuster 22 for adjusting a height (L1) of the guide member 21, and a position alignment unit 20 that aligns a position of the outlet port 2c formed in the guide member 21 with a position of the lateral branch opening e. A surface of the guiding tool 2 is formed by electrocasting.

### <Guide Member>

The guide member 21 is formed from a tubular member that includes the inlet port 2a formed at an upper end part, the hollow portion 2b formed from the upper end part to a tip end part side surface, the outlet port 2c serving as a lower side opening end of the hollow portion 2b, and a curved portion 2e formed on a front side of the outlet port 2c. As shown in FIG. 3, a scale 2f originating from a central part of the outlet port 2c toward the base end part, the knob 2g formed at the upper end part, a male screw part 2h formed below the knob 2g, and a sign 2i (see FIG. 1) formed on the knob 2g are provided to an outer peripheral surface 2d of the guide member 21. Since the root canal b is not always straight, the guide member 21 is preferably formed from a flexible guide pipe member having elastically deformable elasticity, for example, so as to be adaptable to the curved root canal b as well. The guide member 21 is made of a metal such as stainless steel or of a resin, for example.

Here, the knob 2g is formed at a larger diameter than the outer peripheral surface 2d of the guide member 21 so as to be pinched easily. Instead, the knob 2g may be formed at the same diameter as the outer peripheral surface 2d so as to be able to put the adjuster 22 easily from above.

As shown in FIG. 2, the inlet port 2a is an insertion port to insert the needle portion 32. The inlet port 2a is formed at the center of an upper end surface of the guide member 21 (the knob 2g).

An opening edge of the inlet port 2a may be formed into a tapered shape so that the tip end of the needle portion 32 can be inserted easily.

The hollow portion 2b is a void portion to which the needle portion 32 is to be inserted, and is formed into a tubular shape. The hollow portion 2b is formed to extend from the inlet port 2a in the direction to the tip end of the guiding tool 2 with its tip end part being curved in a direction to the outlet port 2c.

The outlet port 2c is an opening in the form of a lateral hole where the tip end part side of the needle portion 32 inserted into the hollow portion 2b is led out from the inside of the hollow portion 2b. The outlet port 2c is formed at the lower end part of the outer peripheral surface 2d of the guiding tool 2. In other words, the outlet port 2c is open in a direction different from a direction of introduction of the dental treatment tool 3. Accordingly, the outlet port 2c is formed to be capable of leading out the needle portion 32 inserted into the hollow portion 2b in the direction of presence of the lateral branch d.

The curved portion 2e is formed in such a way as to curve a lower end part of the hollow portion 2b in an arc shape. The curved portion 2e is formed in a bent manner so as to guide the lower end part of the hollow portion 2b, that extends straight from the inlet port 2a toward a lower end part of the guide member 21, in the direction to the outlet port 2c.

The scale 2f is a dimension display unit that indicates a distance L1 (see FIG. 2) from the central part of the outlet port 2c. The scale 2f is formed from notches provided by the millimeter and numerals indicating lengths in millimeters. The scale 2f is engraved in a vertical direction on the outer peripheral surface 2d (a surface) of the guide member 21. Meanwhile, it is also possible to render the display of the scale 2f more discernible by indicating the dimensions from the central part of the outlet port 2c or carrying out color-coded display.

As shown in FIG. 2, the knob 2g is a rotary operation part to be pinched with fingers and the like in the case of aligning a position of the sign 2i with the position of the outlet port 2c or adjusting the position of the adjuster 22 in conformity with the length L1 from a measurement reference point f to the central part of the lateral branch opening e in order for the operator to bring the position of the outlet port 2c in line with the direction of presence of the lateral branch opening e. The shape of the knob 2g is not limited to a particular shape and may be changed as appropriate. The knob 2g is formed into a shape of any of a disc, a nut, and a polygonal plate, for example. Note that this knob 2g may be omitted. In that case, an upper end part of the male screw part 2h projecting upward from the adjuster 22 is directly pinched and operated.

The male screw part 2h is a threaded engagement part to be threadedly engaged with a female screw part 22a of the adjuster 22.

The male screw part 2h is a guide part formed at an upper part of the tubular guide member 21 and used to vertically move the adjuster 22.

As shown in FIG. 1, the sign 2i is a mark indicating the direction of presence of the outlet port 2c. In order to align the position of the outlet port 2c with the position of the lateral branch opening e, the sign 2i is formed in the same direction as the position of the outlet port 2c in plan view. The sign 2i is formed from a triangular mark, for example.

### <Adjuster>

As shown in FIG. 2, the adjuster 22 is a rotary operable member which is disposed in a state of bringing its lower surface into contact with an upper surface (the measurement reference point f) of the tooth a to be treated in the case of treating the tooth a to be treated. The adjuster 22 is a rotary operation part that moves vertically by being subjected to rotary operation, thus performing adjustment of the height so as to bring the distance L1 from the measurement reference point f to the outlet port 2c in line with a distance from the upper surface of the tooth a to be treated to the central part of the lateral branch opening e. The adjuster 22 is formed from a nut-shaped member or a cylindrical plate-shaped member (a ring-shaped member) subjected to a knurl formation process.

### <Position Alignment Unit>

As shown in FIGS. 2 and 3, the position alignment unit 20 is a mechanism for performing the position alignment to align the position of the outlet port 2c with the position of the lateral branch opening e of the lateral branch d formed at the root canal b of the tooth a to be treated. The position alignment unit 20 is configured to bring the length in the height direction of the lateral branch d and in the opening direction of the lateral branch d, which are measured by using the root canal meter and the lateral branch position detection unit of the not-illustrated lateral branch opening direction detection device, with the distance L1 from the lower surface of the adjuster 22 to the outlet port 2c of the dental treatment tool guiding device 1 and with the direction of the sign 2i. The position alignment unit 20 includes the adjuster 22 that can perform position alignment in the height direction of the lateral branch d and in the opening direction of the lateral branch d, and the guide member 21. The guide member 21 includes the male screw part 2h threadedly engaged with the female screw part 22a of the adjuster 22, the scale 2f and the sign 2i.

### <<Operation>>

Next, an operation of the dental treatment tool guiding device 1 according to this embodiment will be described in the order of work procedures with reference to FIGS. 1 to 3.

### <Step of Preparation>

Prior to the use of the dental treatment tool guiding device 1, an infected part of a caries in the tooth a to be treated is first removed by using the cutting tool, and then the cut portion is further enlarged so as to facilitate the treatment. Next, an entrance of the root canal b shown in FIG. 2 is enlarged with a drill so that the guide member 21 can enter easily.

### <Step of Lateral Branch Measurement>

Subsequently, the presence or absence of the lateral branch d, the position of the lateral branch d, the opening direction (an angle) of the lateral branch d, and the distance L1 from the measurement reference point f (the opening of the root canal b) to the central part of the lateral branch opening e are measured by using the commercially available lateral branch opening direction detection device (see Patent Literature 1). The position of the outlet port 2c of the guiding tool 2 is determined based on measurement results of these values.

### <Step of Confirmation of Lateral Branch Opening by Using Root Canal Camera>

Subsequently, the adjuster 22 is subjected to the rotary operation as shown in FIGS. 2 and 3, whereby the distance L1 from the lower surface of the adjuster 22 to the central part of the outlet port 2c is brought in line with the distance from the upper surface of the tooth a to be treated to the central part of the lateral branch opening e. Moreover, the sign 2i (see FIG. 1) of the guiding tool 2 is set in alignment with the opening direction of the lateral branch d. In this state, the guide member 21 of the guiding tool 2 is inserted into the root canal b. Next, the root canal camera (not shown) is inserted into the inlet port 2a of the guiding tool 2 and a tip end of the camera is aligned with the outlet port 2c. Then, the lateral branch opening e is located by checking images of an inner wall of the root canal b, and the alignment of the position of the outlet port 2c with the position of the lateral branch opening e is confirmed.

Here, only the “step of the lateral branch measurement” may be carried out while omitting the “step of confirmation of the lateral branch opening by using the root canal camera”.

### <Step of Position Alignment>

When the position of the outlet port 2c and the position of the lateral branch opening e are misaligned, the sign 2i is adjusted to the angle of the opening direction of the lateral branch d measured with the lateral branch opening direction detection device by rotating the knob 2g. Accordingly, it is possible to align the opening direction (the angle) of the lateral branch opening e with the opening direction (the angle) of the outlet port 2c of the guide member 21.

The adjuster 22 shown in FIG. 2 is subjected to the rotary operation while maintaining the aforementioned state. Thus, the distance L1 from the lower surface of the adjuster 22 to the outlet port 2c is brought in line with the distance L1 from the upper surface of the tooth a to be treated to the central part of the lateral branch opening e. Accordingly, it is possible to align the position in the vertical direction of the outlet port 2c with the position in the vertical direction of the lateral branch opening e. In this state, the adjuster 22 is fixed to the measurement reference point f of the tooth a to be treated.

### <Step of Treating, Irrigating, and Filling Inside of Lateral Branch>

Next, the root canal camera is pulled out of the guiding tool 2 in this state. Subsequently, the inside of the lateral branch d is treated by inserting the dental treatment tool 3 such as the reamer into the guide member 21. Next, the inside of the lateral branch d is irrigated by inserting the dental treatment tool 3 such as the water pipe and the air pipe into the guide member 21. Thereafter, the treatment is completed by filling the lateral branch d and the like with a root canal filler material (agent).

Here, the operation to pull the camera out of the guiding tool 2 is unnecessary when the “step of confirmation of the lateral branch opening by using the root canal camera” is omitted.

As described above, the present invention provides the dental treatment tool guiding device 1 for guiding the dental treatment tool 3 to the position g to be treated of the tooth a to be treated as shown in FIGS. 1 to 3, which includes the guiding tool 2 provided with the inlet port 2a, the hollow portion 2b, and the outlet port 2c for inserting the dental treatment tool 3 and configured to guide the dental treatment tool 3. Here, the outlet port 2c is open in a direction different from a direction of introduction of the dental treatment tool 3, and the hollow portion 2b extends from the inlet port 2a to the direction of the tip end of the guiding tool 2 and a tip end part side of the hollow portion 2b is curved in the direction to the outlet port 2c.

Accordingly, the dental treatment tool guiding device 1 of the present invention has the hollow portion 2b which extends from the inlet port 2a to the direction of the tip end of the guiding tool 2 and the tip end part side of the hollow portion 2b is curved in the direction to the outlet port 2c, and can thus guide the dental treatment tool 3 to the position g to be treated easily and at high accuracy. This makes it possible to treat the position g to be treated easily even when the position g to be treated is located out of sight of the operator.

As described above, the outlet port 2c is formed at the outer peripheral surface 2d of the guiding tool 2 as shown in FIGS. 1 to 3.

Accordingly, the outlet port 2c is formed at the outer peripheral surface 2d of the guiding tool 2 whereas the lateral branch d is formed substantially in an orthogonal direction to the direction of extension of the root canal b into which the guiding tool 2 is inserted, for example. Therefore, it is possible to align the direction of the outlet port 2c with the direction of extension of the lateral branch d. For this reason, even when the lateral branch opening e is located out of sight of the operator, it is possible to guide the dental treatment tool 3 to the direction of the lateral branch opening e easily and to orient the tip end part of the dental treatment tool 3 toward the lateral branch d easily, thus facilitating the treatment of the inside of the lateral branch d.

Meanwhile, as shown in FIGS. 2 and 3, it is preferable to provide the position alignment unit 20 for positioning the outlet port 2c at the lateral branch opening e of the lateral branch d formed at the root canal b of the tooth a to be treated.

Accordingly, the position alignment unit 20 can locate the position of the outlet port 2c easily at the lateral branch opening e even when the position of the lateral branch opening e cannot be visually confirmed.

In the meantime, as shown in FIGS. 2 and 3, the position alignment unit 20 preferably includes the adjuster 22 that can align the positions in the height direction of the lateral branch d and in the opening direction of the lateral branch d.

Accordingly, the position alignment unit 20 can easily align the positions in the height direction of the lateral branch d and in the opening direction of the lateral branch d by using the adjuster 22.

Meanwhile, the guiding tool 2 is preferably made of a flexible material.

Accordingly, even when there is the curved portion 2e inside the hollow portion 2b in the case of inserting the guiding tool 2 into the hollow portion 2b, the guiding tool 2 can be elastically deformed along the curved portion 2e and guided to the direction of the lateral branch opening e.

In the meantime, the guiding tool 2 is preferably formed by electrocasting.

Accordingly, it is possible to provide the scale 2f shown in FIGS. 1 and 2 precisely since the guiding tool 2 is formed by electrocasting.

Meanwhile, as shown in FIGS. 1 and 3, the scale 2f originating from the central part of the outlet port 2c is preferably provided on the surface of the guiding tool 2.

Accordingly, the guiding tool 2 can indicate the position of the lateral branch d that cannot be visually confirmed directly or the depth of the periodontal pocket h (see FIG. 10) by means of visually checking the scale 2f.

In the meantime, the dental treatment tool 3 is preferably any of the treatment unit for enlarging, irrigating, drying, or sterilizing the lateral branch d formed at the root canal b of the tooth a to be treated, and the observation unit for observing the inside of the lateral branch d.

Here, the treatment unit is used for treating the tooth a to be treated, which is any of a reamer, a file, a Gates drill, a cleanser, a square broach, a scaler, a radiation nozzle (a radiation fiber) of a dental laser treatment device, a scaler chip for an ultrasonic root canal treatment instrument, a water pipe, an air supply pipe, a medical solution supply pipe, a spray pipe, an exhaust pipe, a drain pipe, and the like.

Meanwhile, the observation unit is a device for monitoring the lateral branch d, which is a root canal camera or the like.

Accordingly, the dental treatment tool 3 can be used as the observation unit for observing the inside of the lateral branch d or used for enlarging, irrigating, drying, or sterilizing the lateral branch d when treating the lateral branch d. Thus, the dental treatment tool 3 is adaptable to various treatment tools and is therefore useful.

### First Modified Example

Note that the present invention is not limited only to the above-described embodiment and various modifications and changes are possible within the range of the technical idea of the invention. It is needless to say that those modifications and changes are also encompassed by the scope of the present invention. In the following, the constituents which have been already discussed will be denoted by the same reference signs and explanations thereof will be omitted.

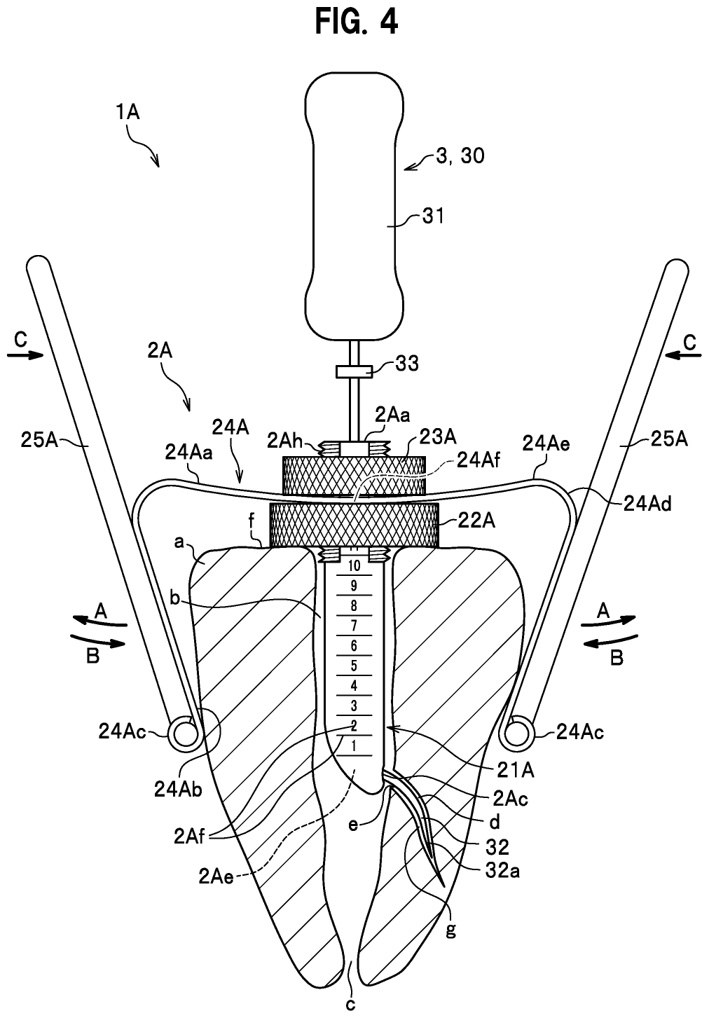

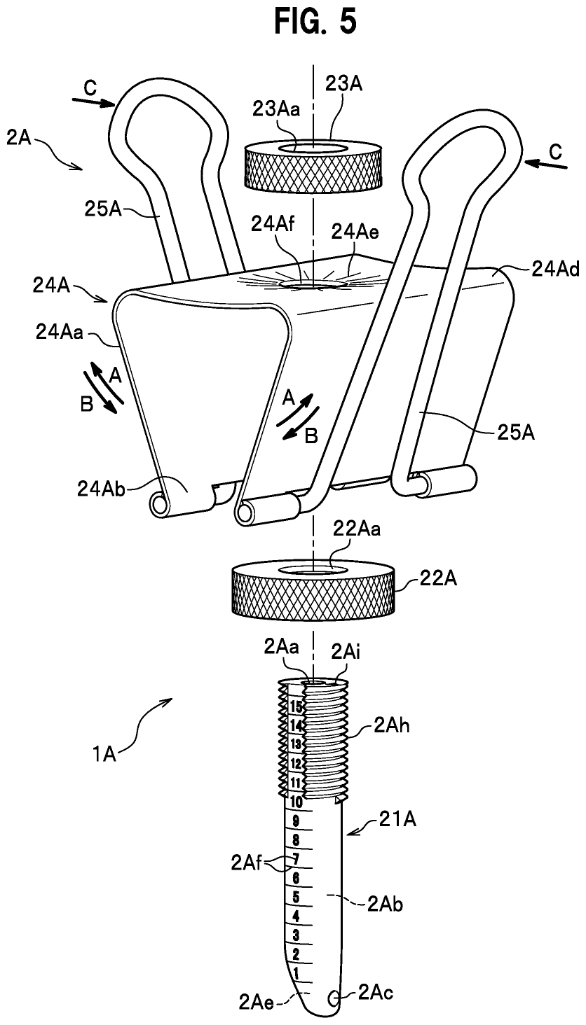

FIG. 4 is a schematic enlarged front view showing a first modified example of the dental treatment tool guiding device according to the embodiment of the present invention. FIG. 5 is a schematic enlarged exploded perspective view showing the first modified example of the dental treatment tool guiding device according to the embodiment of the present invention.

As shown in FIGS. 4 and 5, a guiding tool 2A may include, for example, a fixation unit 24A to be fixed to the tooth a to be treated.

Accordingly, the guiding tool 2A can be fixed to the tooth a to be treated stably since the guiding tool 2A includes the fixation unit 24A. For this reason, the guiding tool 2A does not have to be supported with a hand and the like so that the dental treatment tool 3 can be easily inserted into the guiding tool 2A. Meanwhile, since the guiding tool 2A includes the fixation unit 24A, it is possible to easily align a reference position detected by a measurement device such as the lateral branch opening direction detection device with a reference position of the guiding tool 2A.

In the meantime, as shown in FIG. 4 or 5, the fixation unit 24A includes pinching portions 24Ab that pinch the tooth a to be treated from a direction on a buccal side or a lingual side, an opening direction indication portion 24Ae provided on a base end part side of the pinching portions 24Ab and designed to indicate the opening direction of the lateral branch opening e of the lateral branch d formed at the root canal b of the tooth a to be treated, and a guiding tool insertion hole 24Af for inserting the guiding tool 2A. The guiding tool 2A is preferably configured such that the reference position of the guiding tool 2A is aligned with the reference position of the lateral branch d detected by the lateral branch opening direction detection device.

Accordingly, the fixation unit 24A includes the pinching portions 24Ab that pinch the tooth a to be treated from the direction on the buccal side or the lingual side as shown in FIG. 4, so that the fixation unit 24A can fix the guiding tool 2A in a stable state while pinching the tooth a to be treated. Thus, the treatment can be conducted easily. Moreover, the fixation unit 24A includes the opening direction indication portion 24Ae for indicating the opening direction of the lateral branch opening e, so that the fixation unit 24A can indicate the opening direction of the lateral branch d which is located out of sight. Thus, it is possible to eliminate groping for the lateral branch d. Meanwhile, since the guiding tool 2A can align the reference position of this guiding tool 2A with the reference position of the lateral branch d detected by the lateral branch opening direction detection device, it is possible to clearly understand the position (the angle) of the lateral branch d and the height of the lateral branch opening e.

In the case of the first modified example of the present invention, a guide member 21A of the guiding tool 2A may be provided separately from an adjuster 22A or a fastener 23A as shown in FIG. 4 or 5. The guide member 21A includes an inlet port 2Aa, a hollow portion 2Ab, an outlet port 2Ac, a curved portion 2Ae, a scale 2Af, a male screw part 2Ah, and a sign 2Ai. The sign 2Ai is a triangular mark that indicates the opening direction of the lateral branch opening e. The sign 2Ai is drawn on an upper end surface of the guiding tool 2A while orienting the sign 2Ai in the same direction as a direction of the outlet port 2Ac in plan view.

The adjuster 22A and the fastener 23A are nut-shaped members provided with female screw parts 22Aa and 23Aa, respectively. The adjuster 22A and the fastener 23A are threadedly attached to the male screw part 2Ah in such a way as to sandwich the upper surface of the fixation unit 24A in the vertical direction. It is possible to adjust a distance from a central part of the outlet port 2Ac to a lower surface of the fastener 23A that serves as the measurement reference point f by adjusting the positions of the adjuster 22A and the fastener 23A to be threadedly attached to the male screw part 2Ah.

The fixation unit 24A is formed from a fixation unit body 24Aa in a binder clip shape formed by a leaf spring member that is folded into a triangle in lateral view.

The pinching portions 24Ab having spring force for pinching and fixing the tooth a to be treated are formed on the right and left of the fixation unit body 24Aa. Pivots 24Ac that pivotally support levers 25A for spreading the pinching portions 24Ab outward, respectively, are provided at right and left lower end parts of the fixation unit body 24Aa. The guiding tool insertion hole 24Af for installing the guiding tool 2A, and the opening direction indication portion 24Ae for indicating the opening direction of the outlet port 2Ac are provided on a flat surface on an upper side of the fixation unit body 24Aa.

The opening direction indication portion 24Ae is an angular scale used for aligning the opening direction (the angle) of the lateral branch opening e. The opening direction indication portion 24Ae is drawn or engraved radially around the guiding tool insertion hole 24Af.

The levers 25A are formed from a pair of right and left members, which are made of a metallic rod member and formed substantially into an a-shape in lateral view. When the right and left levers 25A are moved in directions of arrows C, the pinching portions 24Ab spread outward (in directions of arrows A) about right and left bent parts 24Ad of the fixation unit body 24Aa. When fingers are released from the levers 25A, the pinching portions 24Ab automatically restitute in directions back to the original positions (in directions of arrows B) with the spring force of these pinching portions 24Ab, thereby successfully pinching the tooth a to be treated.

Next, work procedures of a dental treatment tool guiding device 1A of the first modified example of the present invention will be described.

First, as shown in FIGS. 1 to 3, the “step of preparation”, the “step of lateral branch measurement”, the “step of confirmation of the lateral branch opening by using the root canal camera” are carried out as with the embodiment, for example. Next, a step of position alignment is carried out in order to align the position of the lateral branch d by using the guide member 21A and the adjuster 22A shown in FIG. 4. At this point, the opening direction of the lateral branch d and the distance L1 from the measurement reference point f to the lateral branch opening e are determined.

Subsequently, the pinching portions 24Ab of the fixation unit 24A are opened by using the levers 25A such that the male screw part 2Ah of the guide member 21A projecting from the adjuster 22A passes through the guiding tool insertion hole 24Af of the fixation unit 24A, and the fixation unit 24A is put over the tooth a to be treated from above. Next, the pinching portions 24Ab are closed in such a way as to pinch the tooth a to be treated with the pinching portions 24Ab of the fixation unit 24A from the directions on the buccal side and the lingual side (a step of attaching a fixation unit).

Subsequently, the fastener 23A is threadedly attached to a portion of the male screw part 2Ah projecting from the fixation unit 24A, and the guiding tool 2A is fixed to the measurement reference point f of the tooth a to be treated (a step of attaching a guiding tool).

Accordingly, it is possible to fix the guiding tool 2A to the tooth a to be treated and the guide member 21A and the outlet port 2Ac can be fixed in a state of being aligned with the lateral branch opening e inside the root canal b. As a consequence, the fixation unit 24A can facilitate the work in the “step of treating, irrigating, and filling the inside of the lateral branch” to be carried out later.

### Second Modified Example

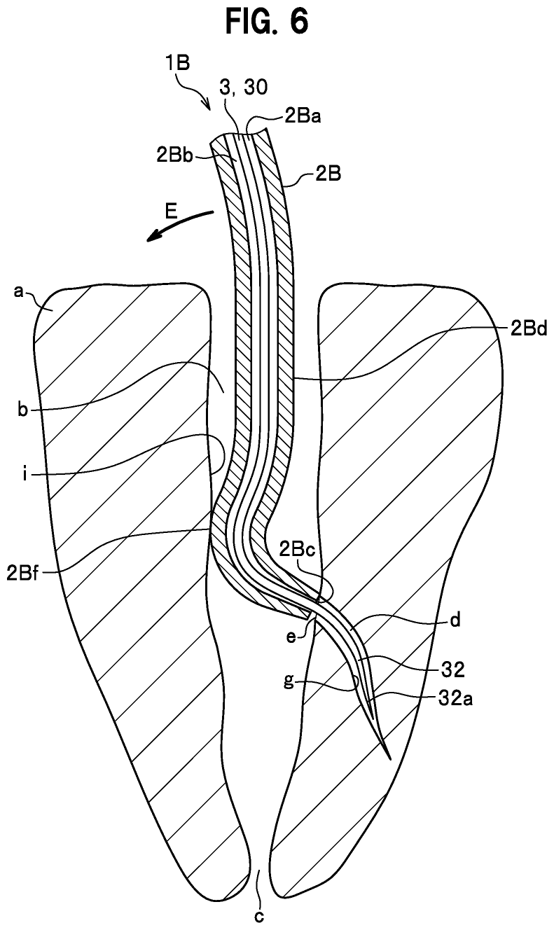

FIG. 6 is an enlarged schematic vertical cross-sectional of a substantial part showing a second modified example of the dental treatment tool guiding device according to the embodiment of the present invention.

As shown in FIG. 6, a guiding tool 2B is preferably provided with a guide protrusion 2Bf on an outer peripheral surface 2Bd on the opposite side of an outlet port 2Bc so as to be brought into contact with an inner wall surface of the root canal b of the tooth a to be treated.

In this case, a dental treatment tool guiding device 1B for guiding the dental treatment tool 3 to the position g to be treated of the tooth a to be treated includes a guiding tool 2B provided with an inlet port 2Ba, a hollow portion 2Bb, and an outlet port 2Bc for inserting the dental treatment tool 3, and configured to guide the dental treatment tool 3. The outlet port 2Bc is formed at a tip end of the guiding tool 2B and is open in a direction different from the direction of introduction of the dental treatment tool 3. The hollow portion 2Bb extends from the inlet port 2Ba in a direction to the tip end of the guiding tool 2B, and its tip end portion side is curved in the direction of the outlet port 2Bc so as to form the outlet port 2Bc to be oriented in the direction of the lateral branch opening e.

As described above, the guiding tool 2B is provided with the guide protrusion 2Bf as shown in FIG. 6, and can therefore perform stabilized guiding while bringing the guide protrusion 2Bf into contact with the inner wall of the root canal b.

Meanwhile, the guide protrusion 2Bf of the guiding tool 2B is used as a fulcrum and a moment is applied to a base end (a support portion) of the guiding tool 2B with finger tips in a direction (a direction indicated with an arrow E) opposite to the lateral branch d by using the principle of leverage. Hence, an end part around the outlet port 2Bc functions as a point of load and comes into contact with the root canal wall i around the lateral branch d. Thus, it is possible to retain the guiding tool 2B in a stable state inside the root canal b and to facilitate the guiding of the dental treatment tool 3 into the lateral branch d.

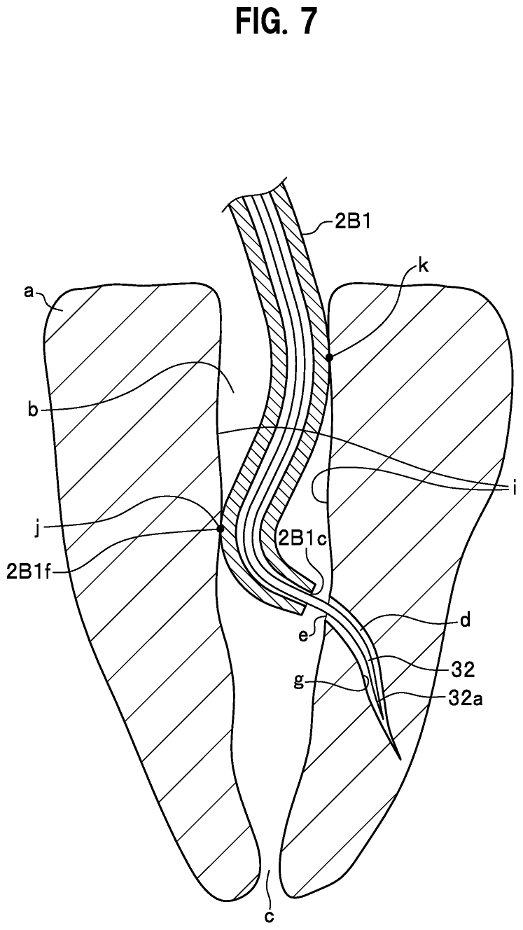

FIG. 7 is an enlarged schematic vertical cross-sectional of a substantial part showing a modified example of the second modified example of the dental treatment tool guiding device according to the embodiment of the present invention.

As shown in FIG. 7, a guiding tool 2B1 may be formed into an S-shape by using an elastic material, for example, whereby two points of a contact point j where a guide protrusion 2B if comes into contact with the inner wall (the root canal wall i) of the root canal b and a contact point k where another portion of the guiding tool 2B1 comes into contact with the root canal wall i of the root canal b, come into contact with the root canal wall i of the root canal b in such a way as to repel each other. Thus, the guiding tool 2B1 may be stably held by using frictional force during the contact.

Furthermore, the guiding tool 2B shown in FIG. 6 may be formed into a spiral shape by using the elastic material so as to cause the guiding tool 2B to come into contact (either point contact or line contact) with the inside of the root canal b in such a way as to spread around, and to be stably held by using frictional force during the contact. In this case, it is possible to keep the guiding tool 2B from shaking in vertical and lateral directions.

### Third Modified Example

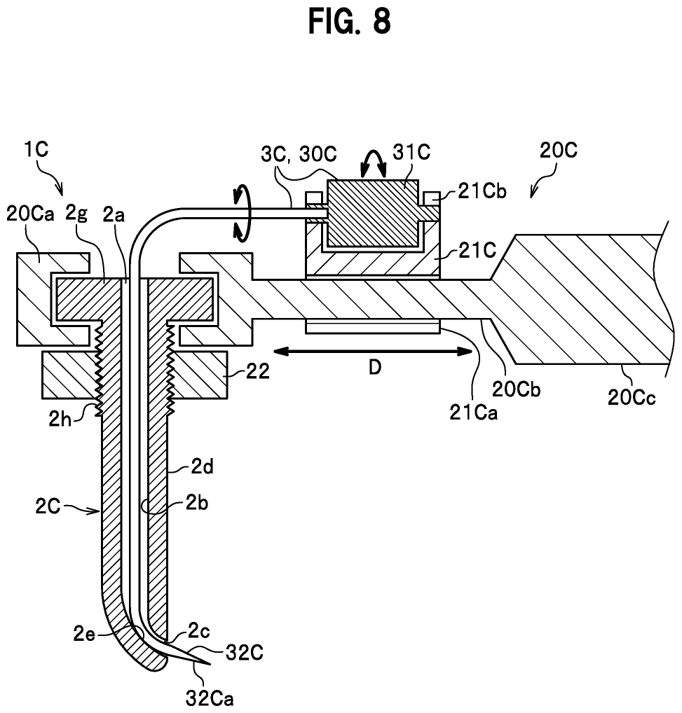

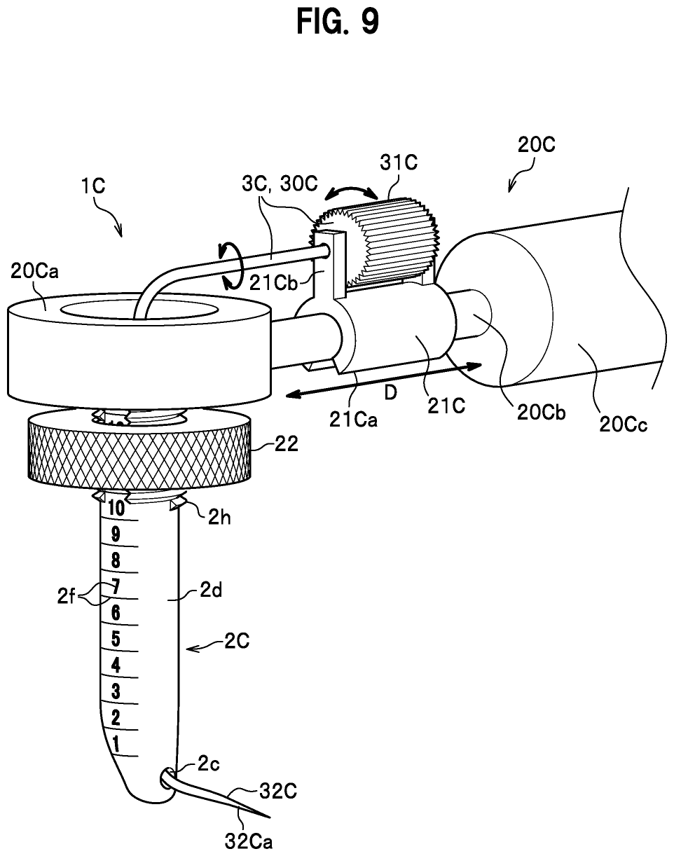

FIG. 8 is an enlarged schematic vertical cross-sectional of a substantial part showing a third modified example of the dental treatment tool guiding device according to the embodiment of the present invention. FIG. 9 is an enlarged schematic perspective of a substantial part showing the third modified example of the dental treatment tool guiding device according to the embodiment of the present invention.

As shown in FIGS. 8 and 9, a dental treatment tool guiding device 1C according to the present invention includes a holder 20C that attachably and detachably holds a guiding tool 2C. The holder 20C includes a rotary support portion 21C that pivotally supports a support portion 31C of a dental treatment tool 3C in a freely rotatable manner, and a guide part 20Cb that supports the rotary support portion 21C in such a way as to be freely movable back and forth. The support portion 31C is preferably configured to be rotated so as to rotate the dental treatment tool 3C in an interlocking manner, and the dental treatment tool 3C pivotally supported by the support portion 31C is preferably moved back and forth by moving the rotary support portion 21C back and forth.

In the case of the third modified example of the present invention, the guiding tool 2C is the same as one of those described in the embodiment, for example.

The holder 20C includes a chuck part 20Ca that holds a knob 2g of the guiding tool 2C, the guide part 20Cb that supports the rotary support portion 21C in such a way as to be freely movable back and forth, and a grip portion 20Cc for conducting a rotating operation and a sliding operation.

The rotary support portion 21C includes a slider part 21Ca fitted to the guide part 20Cb in such a way as to be freely movable back and forth as well as attachable and detachable, and a pivot part 21Cb that pivotally supports the support portion 31C in a freely rotatable manner.

The dental treatment tool 3C includes the support portion 31C pivotally supported by the pivot part 21Cb, and a needle portion 32C provided with a blade part 32Ca at its tip end part.

The support portion 31C is a rotary knob which is provided to the holder 20C so as to enable the rotary operation and the sliding operation by hand.

The needle portion 32C is inserted into the guiding tool 2C in such a way as to be freely rotatable and freely movable back and forth.

Here, the components in the range from the support portion 31C to the needle portion 32C may be formed from spring members or rubber tubes. Thus, these components can transmit the rotation of the support portion 31C to the needle portion 32C.

The dental treatment tool guiding device 1C includes the holder 20C that attachably and detachably holds the guiding tool 2C so that the dental treatment tool guiding device 1C can hold the guiding tool 2C tightly in a stable state. In the meantime, the holder 20C includes the rotary support portion 21C that pivotally supports the support portion 31C of the dental treatment tool 3C in a freely rotatable manner. Thus, it is possible to rotate the blade part 32Ca by rotating the support portion 31C, thereby cutting the position g to be treated. Moreover, the holder 20C includes the guide part 20Cb that supports the rotary support portion 21C in such a way as to be freely movable back and forth. Thus, it is possible to move the rotary support portion 21C forward and backward (in directions of an arrow D), thereby moving the blade part 32Ca back and forth and locating the blade part 32Ca easily at the position g to be treated. As described above, the support portion 31C can perform the treatment easily by conducting rotating operations as well as back and forth movement operations of the dental treatment tool 3C.

### Fourth Modified Example

FIG. 10 is an enlarged schematic vertical cross-sectional of a substantial part showing a fourth modified example of the dental treatment tool guiding device according to the embodiment of the present invention.

In the present embodiment, as shown in FIG. 10, an outlet port 2Dc is preferably formed at a tip end of the guiding tool 2D. Meanwhile, the guiding tool 2D preferably extends from an inlet port 2Da to the direction of the tip end of the guiding tool 2D, and a tip end portion side is preferably curved.

In this case, the dental treatment tool 3D is a handheld scaler called a curette used for conducting a periodontal treatment, namely, scaling and root planing for removing tartar (subgingival calculus) that adheres to a root portion of a tooth inside the periodontal pocket h. The dental treatment tool 3D includes a blade part 32Da located at a tip end side of a needle portion 32D.

The guiding tool 2D includes an inlet port 2Da, a hollow portion 2db, an outlet port 2Dc, a knob 2Dg, a guide portion 2Dj for regulating a direction to guide back and forth directions of the needle portion 32D inserted into the guiding tool 2D, and a curved portion 2Dk formed at a portion near a tip end side of the guide part 2Dj and configured to guide a tip end portion of the blade part 32Da toward the position g to be treated.

As described above, the guiding tool 2D extends from the inlet port 2Da to the direction of the tip end of the guiding tool 2D, and the tip end portion side is curved. Accordingly, it is possible to regulate the tip end portion of the needle portion 32D inserted into the guiding tool 2D in such a way as to be oriented to the direction of the position g to be treated. As a consequence, the position g to be treated can be easily treated by using the blade part 32Da.

Meanwhile, as shown in FIG. 10, the position g to be treated of the tooth a to be treated is preferably located inside the root canal b or inside the periodontal pocket h.

Accordingly, the dental treatment tool guiding device 1D can treat the position g to be treated of the tooth a to be treated, which is located inside the root canal b or inside the periodontal pocket h other than the lateral branch d.

Meanwhile, as shown in FIG. 10, the position g to be treated of the tooth a to be treated is preferably located inside the periodontal pocket h, and the dental treatment tool 3D is preferably formed from any of tools for removing tartar or bacterial plaque, or for incising, resecting, evaporating, or coagulating an inflamed gum or a metabolite generated by bacteria.

As a consequence, the dental treatment tool guiding device 1D can resolve conventional requirements of proper techniques, time, and labor associated with an increase in operational complexity as the periodontal pocket h becomes deeper. The dental treatment tool guiding device 1D can facilitate the operations. Moreover, by replacing the tools used by the dental treatment tool 3D, it is possible to remove the tartar that penetrates deep into the gum, which has been hardly removable in the past. Moreover, it is possible to remove cementum or dentin on a contaminated root surface, thereby obtaining a hard and smooth root surface. Accordingly, residues are less likely to adhere so that gum infections can be resolved and further destruction of periodontal tissues can be suppressed.

Here, the dental treatment tool guiding device 1D only needs to involve the dental treatment tool 3D for removing tartar or bacterial plaque, or for incising, resecting, evaporating, or coagulating an inflamed gum or a metabolite generated by bacteria, which can be inserted into the guiding tool 2D. For example, the dental treatment tool 3D shown in FIG. 10 may be a laser radiation fiber instead of the handheld scaler.

### Other Modified Examples

For example, the fixation unit 24A of the first modified example of the present invention is not limited to the unit of the binder clip shape as shown in FIGS. 4 and 5, but may be of any shape that can be fixed to the tooth a to be treated. The fixation unit 24A may be a fixture such as a small clamp and a small vise.

Meanwhile, the rotary support portion 21C and the support portion 31C of the third modified example of the present invention are not limited only to hand-operated structures as shown in FIGS. 8 and 9 but may be power-operated structures provided with motors and the like. The rotary support portion 21C may be slid by using a motor gear mechanism. Meanwhile, the support portion 31 may be rotated by a motor gear mechanism.

### REFERENCE SIGNS LIST

1A, 1B, 1C, 1D dental treatment tool guiding device
2, 2A, 2B, 2B1, 2C, 2D guiding tool
2a, 2Aa, 2Ba, 2Da inlet port
2b, 2Ab, 2Bb, 2db hollow portion
2c, 2Ac, 2Bc, 2Dc outlet port
2d, 2Bd outer peripheral surface
2f, 2Af scale
2Bf, 2B 1f guide protrusion
3, 3B, 3C, 3D dental treatment tool
20 position alignment unit
20C holder
20Cb guide part
21, 21A guide member
21C rotary support portion
22, 22A adjuster
24A fixation unit
24Ab pinching portion
24Ae opening direction indication portion
24Af guiding tool insertion hole
31, 31C support portion
a tooth to be treated
b root canal
d lateral branch
e lateral branch opening
g position to be treated
h periodontal pocket

1. A dental treatment tool guiding device configured to guide a dental treatment tool to a position to be treated of a tooth to be treated, comprising:
a guiding tool provided with an inlet port, a hollow portion, and an outlet port for insertion of the dental treatment tool, and configured to guide the dental treatment tool, wherein
the outlet port is open in a direction different from a direction of introduction of the dental treatment tool, and
the hollow portion extends from the inlet port to a direction of a tip end of the guiding tool and a tip end part side of the hollow portion is curved in a direction to the outlet port.

2. The dental treatment tool guiding device according to claim 1, wherein the outlet port is formed at an outer peripheral surface of the guiding tool.

3. The dental treatment tool guiding device according to claim 1, wherein
the outlet port is formed at a tip end of the guiding tool, and
the guiding tool extends from the inlet port to the direction of the tip end of the guiding tool and a tip end part side of the guiding tool is curved.

4. The dental treatment tool guiding device according to claim 1, further comprising:
a position alignment unit configured to align a position of the outlet port with a position of a lateral branch opening of a lateral branch formed at a root canal of the tooth to be treated.

5. The dental treatment tool guiding device according to claim 4, wherein the position alignment unit includes an adjuster configured to be able to perform position alignment in a height direction of the lateral branch and in an opening direction of the lateral branch.

6. The dental treatment tool guiding device according to claim 1, wherein the guiding tool includes a fixation unit to be fixed to the tooth to be treated.

7. The dental treatment tool guiding device according to claim 6, wherein
the fixation unit includes:
a pinching portion configured to pinch the tooth to be treated from a direction on a buccal side or a lingual side;
an opening direction indication portion provided on a base end part side of the pinching portion and configured to indicate an opening direction of a lateral branch opening of a lateral branch formed at a root canal of the tooth to be treated; and
a guiding tool insertion hole to insert the guiding tool, and
the guiding tool aligns a reference position of the guiding tool with a reference position of the lateral branch detected by a lateral branch opening direction detection device.

8. The dental treatment tool guiding device according to claim 1, wherein the guiding tool is provided with a guide protrusion on an outer peripheral surface on an opposite side of the outlet port, the guide protrusion being configured to be brought into contact with an inner wall surface of a root canal of the tooth to be treated.

9. The dental treatment tool guiding device according to claim 1, further comprising:
a holder configured to attachably and detachably hold the guiding tool, the holder including
a rotary support portion configured to pivotally support a support portion of the dental treatment tool in a freely rotatable manner, and
a guide part configured to support the rotary support portion in such a way as to be freely movable back and forth,
the support portion is configured to be rotated so as to rotate the dental treatment tool in an interlocking manner, and
the dental treatment tool pivotally supported by the support portion is moved back and forth by moving the rotary support portion back and forth.

10. The dental treatment tool guiding device according to claim 1, wherein
the dental treatment tool is any of
a treatment unit configured to enlarge, irrigate, dry, or sterilize a lateral branch formed at a root canal of the tooth to be treated, and
an observation unit configured to observe inside of the lateral branch.

11. The dental treatment tool guiding device according to claim 3, wherein the position to be treated of the tooth to be treated is located inside a root canal or inside a periodontal pocket.

12. The dental treatment tool guiding device according to claim 3, wherein
the position to be treated of the tooth to be treated is located inside a periodontal pocket, and
the dental treatment tool is formed from any of tools configured to remove tartar or bacterial plaque, or to incise, resect, evaporate, or coagulate any of an inflamed gum and a metabolite generated by bacteria.

13. The dental treatment tool guiding device according to claim 1, wherein the guiding tool is made of a flexible material.

14. The dental treatment tool guiding device according to claim 13, wherein the guiding tool is formed by electrocasting.

15. The dental treatment tool guiding device according to claim 1, wherein a scale originating from a central part of the outlet port is provided on a surface of the guiding tool.
